(19) United States
(12) Patent Application Publication
(10) Pub. No.: US 2005/0115723 A1
(43) Pub. Date: Jun. 2, 2005

(54) Coupling hook

(76) Inventors: Horst Ollefs, Moers (DE); Joachim Laubner, Ahrweiler (DE)

Correspondence Address: HARNESS, DICKEY & PIERCE, P.L.C., P.O. BOX 828, BLOOMFIELD HILLS, MI, 48303, US

(21) Appl. No.: 10/960,270

(22) Filed: Oct. 7, 2004

(30) Foreign Application Priority Data
Oct. 8, 2003 (DE) 10347288.6

(51) Int. Cl. A01B 59/043

(52) U.S. Cl. 172/439

(57) ABSTRACT

A coupling hook (5) for a lower steering arm of a tractor (1) has a hook body (7) with a bearing recess (8) to receive a bearing ball (6) of a to be coupled implement. The hook body has a recess (9), a through hole (10) between the recess (9) and the bearing recess (8), an exiting aperture (11) connecting to the recess (9) and open to the exterior, and a first support element (12) and a second support element (13). The second support element (13) extends through the exiting aperture (11) and separates the exiting aperture into a first opening portion (14) and a second opening portion (15). A locking pawl (17) is movable between a locking position, where it projects into the bearing recess (8), and a detaching position, where it is retracted into the through hole (10). An adjustment element (30) engages the locking pawl (17) and acts on it to take up the locking position. An opening lever (26) is pivotably connected to the locking pawl (17) and is movably supported on the second support element (13). The opening lever (26) has a locking lug (28) to secure the opening lever in a holding position where the locking lug (28) is retainingly engaged in the second opening portion (15).

### CROSS-REFERENCE TO RELATED APPLICATIONS

This application claims the benefit of German Patent Application No. 10347288.6, filed Oct. 8, 2003, the disclosure of the above application is incorporated herein by reference.

### FIELD OF THE INVENTION

The invention relates to a coupling hook for a lower steering arm of a three-point attaching device of a tractor.

### BACKGROUND OF THE INVENTION

DE 42 35 780 C1 (U.S. Pat. No. 5,441,117) describes a coupling hook for a lower steering arm of a three-point attaching device of a tractor. This coupling hook has a hook body with a bearing recess to receive a bearing ball of a to be coupled implement. A recess is formed in the hook body. This recess is open, by means of a through hole, between the recess and the bearing recess towards the bearing recess. Furthermore, an exiting aperture is provided, which is connected to the recess and is open to the exterior.

On the hook body a first support element and a second support element are provided. The second support element is in the form of a spring dowel sleeve. The spring dowel sleeve extends through the exiting aperture and separates the same into a first opening portion and a second opening portion.

The coupling hook further includes a locking pawl. The locking pawl can be moved between a locking position, where the locking pawl projects into the bearing recess, and a detaching position, where the locking pawl is retracted into the through hole. The locking pawl has a locking face. The locking face is arranged opposite to the second support element in the locking position. Thus, the locking pawl is secured in the locking position. In the locking position, the locking pawl is acted upon by an adjustment element for the support on the first support element. The adjustment element is formed as a spring. The adjustment element engages, on the one hand, on the hook body and, on the other hand, on the locking pawl. The adjustment element acts upon the locking pawl to take up the locking position.

Furthermore, the coupling hook has an opening lever, which is movably connected to the locking pawl and is movably supported on the second support element. The opening lever is lead through the first opening portion to the exterior and projects outwards over the hook body. The opening lever has a locking lug, which serves to retain the opening lever in a holding position. In this holding position, which can be reached by pivoting the opening lever by an operating person, the locking lug is supported on an outer edge of the hook body, which is arranged next to the second opening portion. Furthermore, the opening lever is additionally supported on the second support element of the hook body.

In order to move the opening lever into the holding position and the locking pawl into the detaching position and holding the same in this position, it is necessary to pull the opening lever so far out of the hook body that it can be pivoted into the holding position. The force for doing this is large. Furthermore, the movement space necessary for the movement has to be provided. The opening lever projects relatively far outwards over the outer contour of the hook body. The above described two-phase handling and movement is complicated.

U.S. Pat. No. 6,058,633 describes a quick coupling for earth moving equipment. In this quick coupling, for example, a shuffle should be retained on an arm. For this purpose, hook-like coupling elements are provided on the arm in which bolts are received. The bolts are held in an enclosed manner by locking elements in the hook, coupled to a locking lever. The locking levers are, respectively, acted upon by a single-action pressure cylinder.

### SUMMARY OF THE INVENTION

The present invention provides a coupling hook where the motion tracks from the locking position into the detaching position are simplified to improve handling.

The invention provides a coupling hook, especially for a lower steering arm of a three-point attaching device of a tractor, having a hook body. The hook body has a bearing recess to receive a bearing ball of a to be coupled implement. The hook body also has a recess, a through hole between the recess and the bearing recess, and an exiting aperture, connected to the recess and open to the exterior. A support element extends through the exiting aperture and separates the aperture into a first opening portion and a second opening portion. A locking pawl is displaceable between a locking position, where the locking pawl projects into the bearing recess, and a detaching position, where the locking pawl is retracted into the through hole. An opening lever is movably connected to the locking pawl. The opening lever projects through the first opening portion outwards over the hook body. The opening level has a locking lug, which retains the opening lever in a holding position such that the locking lug is held in the second opening portion between the support element and an opposing limiting edge of the second opening portion. The locking lug prevents a return pivoting of the opening lever from the holding position.

Advantageously, the handling is distinctly simplified so that in order to move the locking pawl from the locking position into the detaching position only a pivot movement of the opening lever around the second support element is necessary. A rotational movement is advantageous taking into account the necessary force to be applied.

When a specific pivot angle of the opening lever is exceeded, the locking lug can enter the second opening portion. Under the effect of the adjustment element, which retains the locking pawl in a holding position, it also holds the locking pawl in the detaching position. In the second opening portion, the locking lug is supported on a limiting edge of the second opening portion arranged opposite to the support element. An advantage of the invention is, that by means of the pivot movement, a single-phase actuation is achieved. The opening lever does not need to be pulled out of the hook body by an extreme amount and then pivoted. The projecting dimension of the opening lever in the holding position over the outer edge of the hook body in the area of the exiting aperture is reduced. Thus, the danger of a collision with the to be coupled implement is reduced.

A retaining face, as it is described in DE 42 35 780 C1 (=U.S. Pat. No. 5,441,117), can be formed on the end of the locking pawl. The retaining face can be arranged opposite to the second support element in the locking position or it can be arranged on the lower edge of the locking pawl in the area of a recess. The retaining face can be arranged opposite to the first support element in the locking position, as described in DE 43 15 811 C1 (=U.S. Pat. No. 5,497,835).

In an embodiment of the invention, an adjustment element is provided. The adjustment element, on the one hand, engages on the hook body and, on the other hand, on the locking pawl. The adjustment element acts on the locking pawl to take up the locking position. The adjustment element generates a force loading, which supports the entering of the locking lug into the second opening portion.

Preferably, the hook body has a first support element and a second support element. The first support element represents the support element which extends through the exiting aperture and separates the same into a first opening portion and a second opening portion. The second support element serves to support the locking pawl in the locking position.

Advantageous adjustment conditions exist when the adjustment element is connected to the hook body and the locking pawl. Here a force acting axis, defined by the adjustment element, together with an imagined connecting line, between the pivot axis formed by the second support element for the opening lever and the centre of the attachment element for the adjustment element on the hook body, in the locking position, enclose a first angle of 10° to 14° and in the holding position a second angle of 0° to 4°.

If manual operation of the opening lever is desired to maintain the opening lever in the holding position, a spring element is provided so that upon movement of the opening lever, the spring prevents a self-actuated entering of the locking lug into the second opening portion. After exceeding the holding force of the spring element, when operated by a person, the opening lever can enter, together with the locking lug, into the second opening portion and thus retain the locking pawl in the detaching position.

In a first embodiment, the adjustment element is formed as a helical tensioning spring. Alternatively, the adjustment element is presented as a linear adjustment element which is acted upon by a pressure agent on one side. The adjustment element can be moved by pressurization into an extended position and upon release of the pressure, moves in a self-acting manner back to the retracted initial position. Such an embodiment is necessitated to prevent the opening lever from taking up the holding position. Thus, a spring element is provided, which prevents the self-actuated entering of the locking lug. In the embodiment, which uses a helical tensioning spring as the adjustment element, when it is actuated by an operating person, for example, by a pulling cable, since the pivot angle of the opening lever is predetermined, it determines whether an automatic entering in the holding position can be achieved or not.

Preferably the opening lever has a slot limited on one side by the locking lug. Also, the second support element extends through the slot. Furthermore, it is advantageous, when the first and second support elements are, respectively, represented as a pin. Here, the pins can be formed as spring dowel sleeves.

In an embodiment of the spring element, the spring element externally abuts the hook body when the opening lever is moved. Here, preferably, the spring element is formed rod-like or leaf spring-like. The spring element projects from and is retained at one end on the opening lever.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a tractor and a portion of a to be coupled attachment implement;

FIG. 2 is a side view of a first embodiment of a coupling hook with the locking pawl shown in the locking position and a lid element is removed, to free the view onto the locking pawl and the adjustment element;

FIG. 3 is a view like FIG. 2, where the locking pawl is in the detaching position and the opening lever is in the holding position;

FIG. 4 is a side view of a coupling hook of a second embodiment, with a linear adjustment element actuated by a pressure agent and the locking pawl is arranged in the locking position; and

FIG. 5 is a side view of the coupling hook of FIG. 4, where the locking pawl is arranged in the detaching position and the opening lever is arranged in the holding position.

### DETAILED DESCRIPTION OF THE PREFERRED EMBODIMENTS

The following description of the preferred embodiment(s) is merely exemplary in nature and is in no way intended to limit the invention, its application, or uses.

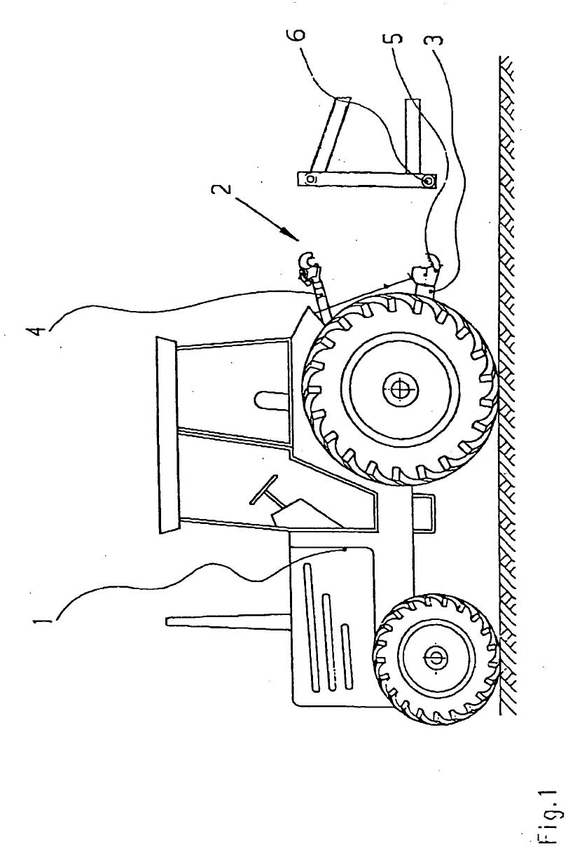

In FIG. 1, a tractor 1 is shown in side view with a three-point attaching device or hitch 2 on its rear. A corresponding three-point attaching device can be attached to the front of the tractor. The three-point attaching device 2 has two lower steering arms 3. The two steering arms are off-set in different directions to a longitudinal axis of the tractor 1 and laterally distanced thereto. Only one of two steering arms is visible, as the other is arranged in the drawing plane behind the visible lower steering arm 3. The lower steering arms 3 are adjusted by a power lift, at the same time, or are adjustable independently, by independent power lifts, to their height position. Thus, the coupling hooks 5, attached to the free ends of the two lower steering arms 3 can be adjusted to their height position with reference to the ground, on which the tractor 1 stands.

The three-point attaching device 2 further includes an upper steering arm 4, which is coupled above the lower steering arm 3, to the rear of the tractor 1. The upper steering arm 4 is centrally positioned on the longitudinal axis of the tractor 1, at the rear of the tractor above the lower steering arm 3.

A coupling frame is arranged on an attachment implement not shown in more detail. The coupling frame has three coupling points, which have bearing balls received on a pin and secured thereon. One bearing ball 6 is visible, which serves to be connected to the visible coupling hook 5.

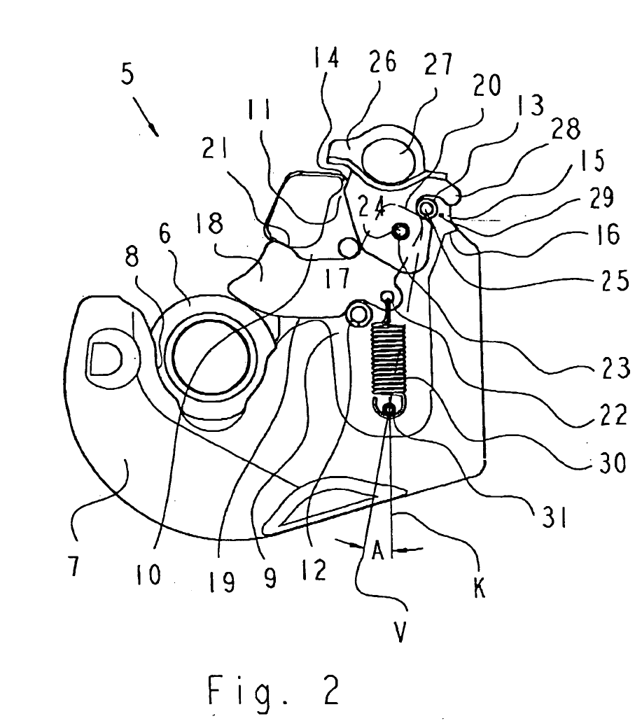

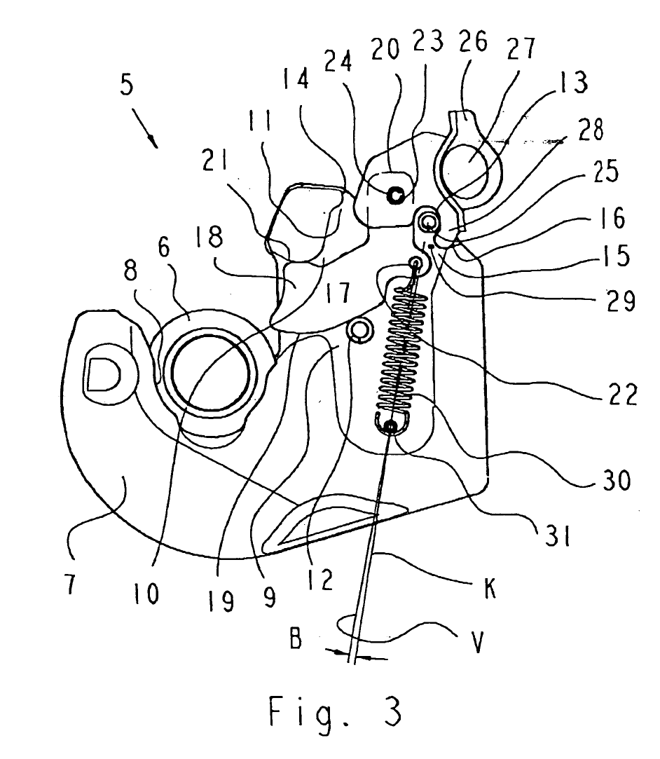

A first embodiment of a coupling hook 5, according to the invention, is described in detail with reference to FIGS. 2 and 3. The coupling hook 5 has a hook body 7, which is, for example, a forged component. This hook body 5 has a spherically formed bearing recess 8. The bearing ball 6, visible in FIG. 1, is received in the coupled condition in the bearing recess 8. The hook body 7 includes a recess 9 normally closed by a lid (not shown). However, in order to be able to describe the individual components better, the lid is omitted. The recess 9 is connected, via a through hole 10, to the bearing recess 8. Furthermore, an exiting aperture 11 is provided to connect the recess 9 to the exterior. A first support element 12 is provided in the recess 9, in the form of a spring dowel sleeve. A second support element 13 is distanced from the first support element toward the exiting aperture 11. The second support element is also in the form of a spring dowel sleeve which extends through the recess 9. The second support element 13, in the form of a spring dowel sleeve, separates the exiting aperture 11 into a first opening portion 14 and a second opening portion 15. The second opening portion 15 is limited by the second support element 13 and a limiting edge 16 of the hook body 7 arranged opposite to the second support element 13.

A locking pawl 17 is accommodated in the recess 9. The locking pawl 17 is curved and has a locking portion 18, which in the locking position shown in FIG. 2, projects into the bearing recess 8 and retains the bearing ball 6 in the bearing recess 8. The locking pawl 17 is guided in a supported manner with its lower edge 19 on the first support element 12. The locking pawl 17 has a projection distanced to the locking portion 18, which is supported on the first support element 12 in the locking position.

The locking pawl 17 is provided on its end distanced from the locking portion 18 with a locking face 20. The locking face 20 is supported, when acting on the locking pawl 17 in the area of the locking portion 18, on the second support element 13. Thus, the locking pawl 17 is secured in the locking position.

The upper edge 21 of the locking pawl 17 is supported against the limitation of the through hole 10, toward the top away from the bearing recess 8, when the locking pawl 17, in the area of the locking portion 18, acts on the bearing ball 6. A retaining bore 22 is provided in the area of the projection of the locking pawl 17, which is arranged in the locking position close to the first support element 12.

Furthermore, a bearing pin 23 is inserted close to the locking face 20 in the locking pawl 17. The bearing pin 23 defines the bearing axis 24. Via the bearing pin 23, an opening lever 26 is pivotably connected to the locking pawl 17.

The opening lever 26 has a fastening bore 27, for example, to fasten a rope. The opening lever 26 is provided with a slot 29, which is limited laterally by a locking lug 28. With the slot 29, the opening lever 26 pivotably engages on the second support element 13 and rests on the same. The second support element 13 forms the pivot axis for the opening lever 26. The opening lever 26 extends through the first opening portion 14 outwards from the hook body 7.

A fastening pin 31 is provided in the hook body. The fastening pin forms an attachment element for a helical tensioning spring 30, representing an adjustment element. The other end of the helical tensioning spring 30 is hung into the retaining bore 22.

The helical tensioning spring 30 pulls the locking pawl 17 into the locking position shown in FIG. 2. To move the locking pawl 17 from the locking position, according to FIG. 2, into the detaching position, the holding position, the opening lever 26, according to FIG. 3, is pivoted in a clockwise direction, via a rope pulley, around the pivot axis 25 formed by the second support element 13. The locking pawl 17 leaves, together with its locking portion 18, the area of the bearing recess 8 and retracts into the through hole 10. In order to pivot the locking pawl 17, the force of the helical tensioning spring 30 has to be exceeded.

If the locking pawl 17 is to be held in the detaching position, the opening lever 26 has to be pivoted a desired distance so that the locking lug 28 can enter the second opening portion 15 between the second support element 13 and the limiting edge 16. The locking lug 28 can be supported on the limiting edge 16. In this case, the opening lever 26 is pulled into this position by the helical tensioning spring 30. Thus, the force acting axis K, in the locking position, has an angular relationship to an imaginary connecting line V. Line V is the line between the pivot axis 25 for the opening lever 26 formed by the second support element 13 and the center of the attachment element 31 for the helical tensioning spring 30 as an adjustment element on the hook body 7. The force acting axis K and imaginary line V enclose a first angle A of about 10° to about 14°, preferably 120. In the holding position, the angular relationship encloses a second angle B of about 0° to about 4°, especially 2°.

If the opening lever 26 and the locking pawl 17 should be moved back into the locking position, the opening lever 26 would be acted on in a counterclockwise direction, so that the locking lug 28 can exit from the second opening portion 15 and leave the abutment on the limiting edge 16. Thus, the locking pawl 17 can again take up the locking position shown in FIG. 2 due to the acting force of the helical tensioning spring 30. If the opening lever 26 is moved into the detaching position only so far so that the locking lug 28 can not enter into the second opening portion 15, the locking pawl 17 returns automatically to its locking position due to the force of the helical tensioning spring 30 when no force is applied.

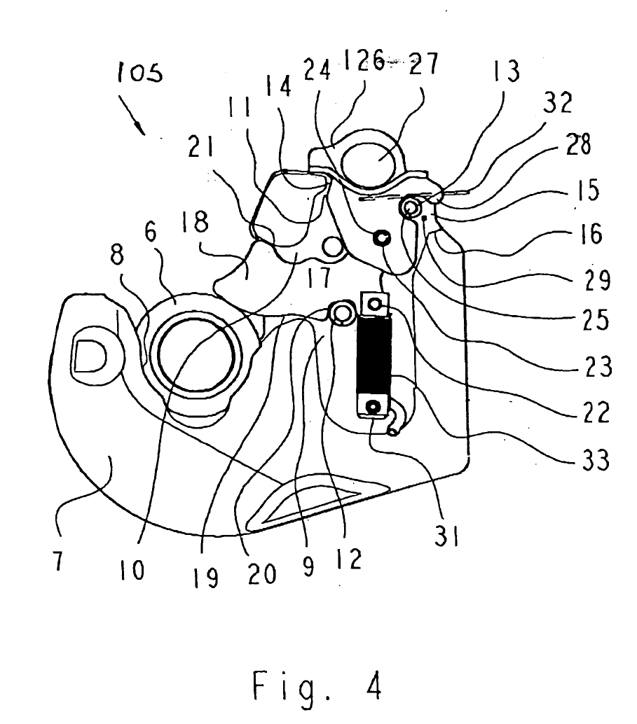

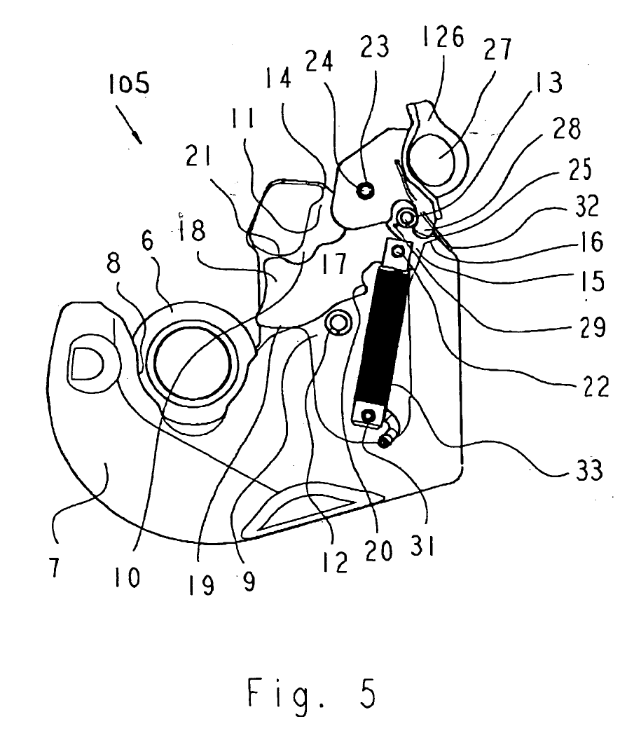

In FIGS. 4 and 5 a coupling hook 105 is shown, which differs from the embodiment of FIGS. 2 and 3 in the following described features. The coupling hook 105 of FIGS. 4 and 5 corresponds to the design of the coupling hook 5 of FIGS. 2 and 3, so that the same reference numerals are used for the same components and portions. Concerning the description, refer to the description concerning the embodiment of the coupling hook 5 of FIGS. 2 and 3.

The coupling hook 105 of FIGS. 4 and 5 differs from that of FIGS. 2 and 3 in that the adjustment element, in the form of a helical tensioning spring provided on the coupling hook 5, is substituted by a linear adjustment element 33. The linear adjustment element 33 can be actuated via a pressure conduit and a pressure source and control devices with compressed air or pressurised oil which changes its length. It can, for example, be formed as a plunger cylinder which is acted upon by compressed air. However, preferably, a design according to co-pending U.S. Ser. No. 10/927,274 entitled Linear Adjustment Element, the specification and drawing of which are expressly incorporated by reference, may be selected.

In such a linear adjustment element 33, generally always the completely extended position is taken up when loaded by pressure. During the pressure release, if it is not prevented, the linear adjustment element 33 returns automatically into the retracted position. During such an actuation, a detaching position is not reached. The locking pawl 7 can automatically return into its locking position, even though the locking lug 28 enters into the second opening portion 15. A spring element 32, formed as a leaf-like spring, is arranged on the opening lever 26. The spring element 32 is held in a recess of the opening lever 26 such that its free end projects over the outer contour of the opening lever 26. This area of the spring element 32, formed leaf spring-like or as a rod, abuts the outer edge of the hook body 7 in the area of the exiting aperture 11 and especially on the outer neighboring area to the limiting edge 16 of the hook body 7. Thus, the opening lever 26 together with its locking lug 28 can only enter into the second opening portion 15 when an operating person consciously, manually, acts onto the opening lever 26 in a clockwise direction. Accordingly, the spring element 32 is deflected and the locking lug 28 can enter into the second opening portion 25. The releasing of this holding position also has to be consciously carried out by an operating person.

Furthermore, the locking face 20 is arranged in this case on a recess in the lower edge 19 of the locking pawl 17. The locking face interacts with the first support element 12. The recess together with the locking face 20 is arranged close to the recess having the retaining bore 22.

The description of the invention is merely exemplary in nature and, thus, variations that do not depart from the gist of the invention are intended to be within the scope of the invention. Such variations are not to be regarded as a departure from the spirit and scope of the invention.

1. A coupling hook, especially for a lower steering arm of a three-point attaching device of a tractor, comprising:
a hook body having a bearing recess for receiving a bearing ball of a to be coupled implement, having a recess, having a through hole between the recess and the bearing recess, having an exiting aperture, connected to the recess and open to the exterior, and having a support element, extending through the exiting aperture and separating the exiting aperture into a first opening portion and a second opening portion;
a locking pawl being displaceable between a locking position where the locking pawl projects into the bearing recess and a detaching position, where the locking pawl is retracted into the through hole;
an opening lever being movably connected to the locking pawl, said opening lever projecting through the first opening portion outwards over the hook body; and
a locking lug retaining the opening lever in a holding position such that the locking lug is held in the second opening portion between the support element and a limiting edge of the second opening portion arranged opposite to the support element, said lug prevents a return pivoting of the opening lever from the holding position.

2. The coupling hook according to claim 1, further comprising an adjustment element engaging the hook body and the locking pawl, said adjustment element acting on the locking pawl to take up the locking position and said adjustment element generating a force loading which supports the entering of the locking lug into the second opening portion.

3. The coupling hook according to claim 1, wherein the hook body has a first support element and a second support element, the second support element extends through the exiting aperture and separates the same into a first opening portion and a second opening portion, and the first support element supports the locking pawl in the locking position.

4. The coupling hook according to claim 2, wherein the adjustment element is connected to the hook body and the locking pawl, a force acting axis defined by the adjustment element together with an imagined connecting line between the pivot axis formed by the second support element for the opening lever and the centre of the attachment element for the adjustment element on the hook body, in the locking position enclose a first angle of about 10° to about 14° and in the holding position enclose a second angle of about 0° to about 4°.

5. The coupling hook according to claim 1, wherein the opening lever has a spring element which, when moving the opening lever, prevents a self-actuated entering of the locking lug into the second opening portion.

6. The coupling hook according to claim 2, wherein the adjustment element is formed as a helical tensioning spring.

7. The coupling hook according to claim 5, wherein the adjustment element is a linear adjustment element which is acted upon by a pressure agent on one side and can be moved by pressurization into an extended position and upon release of the pressure, moves in a self-acting manner back into the retracted initial position.

8. The coupling hook according to claim 2, wherein the opening lever has a slot limited on one side by the locking lug and through which the second support element extends.

9. The coupling hook according to claim 1, wherein the second support element is a pin.

10. The coupling hook according to claim 3, wherein the first support element is a pin.

11. The coupling hook according to claim 9, wherein the pin is formed as a spring dowel sleeve.

12. The coupling hook according to claim 10, wherein the pin is formed as a spring dowel sleeve.

13. The coupling hook according to claim 5, wherein the spring element externally abuts the hook body when the opening lever is moved.

14. The coupling hook according to claim 5, wherein the spring element is formed rod-like or leaf spring-like and is retained at one end on the opening lever and projects therefrom.
